(19) United States
(12) Patent Application Publication
(10) Pub. No.: US 2011/0153501 A1
(43) Pub. Date: Jun. 23, 2011

(54) BUSINESS OBJECT AND SYSTEM FOR ELECTRONIC TRANSACTIONS

(75) Inventors: Gaurav Agarwal, San Francisco, CA (US); James Skinner, Palo Alto, CA (US)

(73) Assignee: MICROSOFT CORPORATION, Redmond, WA (US)

(21) Appl. No.: 12/641,859

(22) Filed: Dec. 18, 2009

(51) Int. Cl. G06Q 30/00; G06Q 10/00; G06Q 50/00; G06Q 20/00; G06F 21/00

(52) U.S. Cl. 705/51; 705/310; 705/26.1

(57) ABSTRACT

A system and method for conducting electronic transactions are provided, in which a business object is employed that includes a plurality of modular object sections that function as agreed-upon standard descriptors of an electronic transaction. The sections of the object may include a quote section, an elections section and a fulfillment section. The quote section contains information relating to a seller's willingness to transfer rights in an asset to a purchaser. The elections section contains transaction parameters that are modifiable in response to input from the purchaser. The fulfillment section contains information pertaining to consummation of the transaction and is configured to enable and facilitate the performance of transaction-related fulfillment tasks by one or more third parties.

### BACKGROUND

Facilitating electronic transactions amongst disparate parties can be challenging. In addition to having different and varied relationships to an electronic transaction (e.g., purchaser, service provider, asset owner, etc.), the parties often employ different systems for participating in electronic transactions. Moreover, a wide variety of types of assets may be the subject of such electronic transactions, which can introduce further complexity into an electronic commerce environment.

### SUMMARY

Accordingly, the present disclosure provides a business object for mediating electronic transactions. The business object includes a plurality of modular object sections that are recognized by different transacting parties as standard agreed-upon descriptors of an electronic transaction to execute different business models. The modular object sections include a quote section, an elections section and a fulfillment section. The quote section is configured to indicate the willingness of a seller to transfer rights in an asset to a purchaser. The elections section contains parameters of the corresponding electronic transaction that are modifiable in response to input received from the purchaser. The fulfillment section contains fulfillment information relating to actions to be taken in order to achieve the transfer of the rights in the asset to the purchaser.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of an embodiment of an example system for conducting electronic transactions.

FIG. 2 shows a flow diagram illustrating an example workflow in accordance with an embodiment of the present disclosure.

FIG. 3 shows a flow diagram illustrating a minimum implementation workflow in accordance with an embodiment of the present disclosure.

FIG. 4 shows a flow diagram illustrating an external purchase workflow in accordance with an embodiment of the present disclosure.

FIG. 5 shows an example flow diagram for a purchasing process in accordance with an embodiment of the present disclosure.

### DETAILED DESCRIPTION

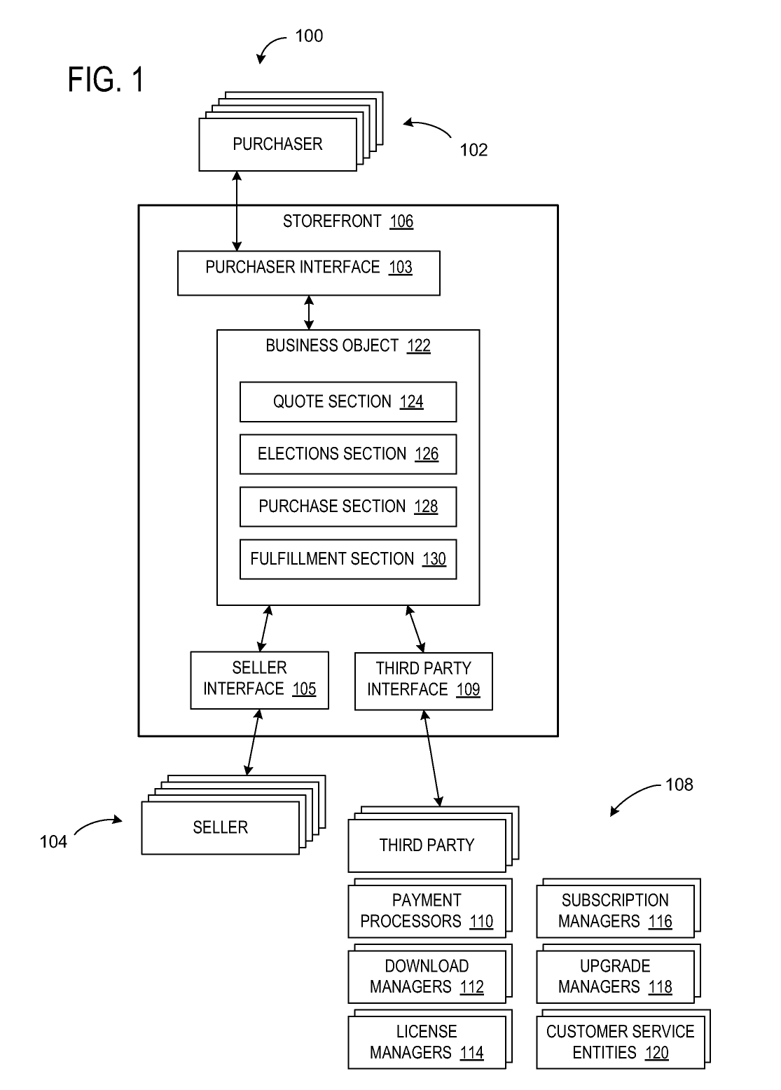

FIG. 1 depicts a system 100 for conducting electronic transactions. As indicated in the figure, a number of different participants can play a role in electronic transactions. In addition to purchasers 102 and sellers 104, potential participants may include an electronic storefront 106 and one or more third parties 108. As described in more detail below, electronic storefront 106 may provide a mediator role in connection with transactions, which may include interacting with sellers to create and modify sales offers, identifying offers of interest and presenting those offers to candidate purchasers, and/or coordinating with third parties to perform other roles in connection with consummating transactions. Third parties 108 may include payment processors 110, download managers 112, license managers 114 (e.g., for DRM-enabled assets), subscription managers 116, upgrade managers 118, customer service entities 120, etc., to name but a few non-limiting examples. Further, purchasers 102, sellers 104 and third parties 108 may interact with storefront 106 in any suitable manner. For example, purchasers 102 may interact with storefront 106, and various potential transactions offered via storefront 106, via a purchaser interface 103. Likewise, sellers 104 may utilize a seller interface 105. Further, third parties 108 may interact with storefront 106 via a third party interface 109 to perform various transaction fulfillment actions.

Achieving efficient interaction amongst disparate parties can be challenging. In addition to having different and varied relationships to an electronic transaction (e.g., purchaser, service provider, asset owner, etc.), the parties often employ different systems for participating in electronic transactions. Moreover, a wide variety of types of assets may be the subject of electronic transactions, which can introduce further complexity into an electronic commerce environment. The large number of variables in play can often result in specialization. For example, a purveyor of digital music might design and deploy a specialized storefront interface including payment and license grant mechanisms that are particular to the sale of digital music assets. However, such a specialized system might not be well-suited to transactions involving other types of assets, such as the sale of digital video assets on a television or a personal computer.

Accordingly, to variously address some of these interaction challenges, the present system may employ a business object 122 for facilitating electronic transactions. As will be described in more detail and in various examples, business object 122 may be configured to provide modular object sections that function as standard, agreed-upon descriptors of an electronic transaction. In one embodiment, the business object may include a quote section 124, an elections section 126, a purchase section 128 and a fulfillment section 130. Typically, the read/write permissions vary from section to section, depending on the relationship of a given entity to the transaction. The business object may also be described by a type field, for example contained within the business object, which identifies the specific read/write behaviors that are permissible for this type of object.

Generally, quote section 124 includes or represents the willingness of a seller to grant or transfer rights in an asset to a purchaser. In other words, the quote section can be thought of as containing or describing an offer and its conditions that is made to a candidate customer—e.g., a single video purchase for $4.00 that can be played back on the television. As such, the quote section may indicate willingness of a seller to transfer rights in an asset to a purchaser in exchange for consideration provided by the purchaser. Further, the quote section may be modifiable so as to cause transformation of a viewable representation presented to the purchaser.

Elections section 126 is configured to store transaction parameters that are modifiable in response to user input received from an interested purchaser. For example, elections section might be employed to store a customer's election to pay for and download only selected episodes of a television series. Another example would be to track the customer's desire to employ a credit card or other payment mechanism, and/or to stored related payment information. Many other examples are possible, including coupons.

Purchase section 128 is configured to store information associated with payment, and may contain information about the specific purchase transaction on a quote between the purchaser and the seller. For example, in addition to or instead of storing payment information within elections section 126, such information may be retained in purchase section 128 after appropriate information and input is received via elections section 126 (e.g., credit card information; purchase confirmations; actual purchase price, such as after a coupon; and/or any other information the purchase processing system may want to relay to the user such as the credit card being rejected, the purchase failing, the purchase succeeding, etc.).

Fulfillment section 130 may be employed to contain other information associated with fulfillment/performance of the transaction. In some cases, the information will be related to actions that are to occur after the customer's initial acceptance of the sales offer. For example, the fulfillment section 130 may be employed to store a list of deliverables that are to be provided to the customer (e.g., downloadable files). Accordingly, a third party download administrator could consult the fulfillment section to determine what downloads to provide to the customer and/or what encryption keys or license grants should be generated and provided to the customer. As discussed below, a wide variety of possibilities exist for fulfillment section 130, and the section may be used to leverage efficient participation of third parties to perform various transaction-supporting functions. Further, there may be one or more fulfillments per object/offer such as, for example, fulfilling a VOD, DVD and an action figure each from different providers.

Many potential benefits may be achieved through use of a modular business object, such as business object 122. As previously discussed, business object 122 provides a standard, agreed-upon mechanism for facilitating interaction between various parties involved in an electronic transaction. The standardized nature of the object can produce significant efficiencies, many of which flow from the fact that the various parties understand and recognize the object and its component parts, and understand how to work with and access the object in order to perform particular roles in connection with the transaction. The reduced communication overhead can allow for a variety of scenarios where particular transaction-related tasks are delegated to the entities that are most efficiently positioned to perform those tasks. Standardized object sections can greatly increase the ability to search for, view and modify offers for particular assets. Standardized sections and the modularity of the object can also enable generation of complex offers involving multiple assets, and/or offers on related assets using cross promotion. Sales offers can be provided to address assets of widely varying types from a variety of different unaffiliated sellers, and offers for digital assets can be provided to accommodate demand for formats suited to different device types (e.g., personal computer, mobile device, television, etc.). Further, the modularity of the interaction mechanism provided by business object 122 can provide significant opportunities to extend existing systems and support a variety of flexible business models.

The various benefits recited above are illustrative and non-limiting, and may be achieved through deployment of business object 122 in a wide variety of use scenarios. In many exemplary use scenarios, business objects are employed in connection with a centralized entity, such as the electronic storefront 106 shown in connection with electronic commerce system 100. As previously indicated, the business objects represent potential transactions that can occur between a seller and a purchaser. Generally, an offer is presented to a potential purchaser by presenting a viewable representation of information contained in the quote section of one of the business objects. If interested, the candidate purchaser responds with various inputs that are stored in the elections section of the relevant business object. Based on the elections made by the purchaser, payment and delivery then occurs based on information contained in the purchase and fulfillment sections of the business object. Depending on the nature of the transaction, a variety of other actions may occur in connection with fulfillment, as will be described in various examples below. In some embodiments, many business objects may be utilized for a single asset. Further, different business objects may each have a different transaction condition, such as price or another such condition, associated with a same asset. However, many business objects may also be utilized for many assets. In such a case, the many assets are typically not randomly chosen, but rather, may be a grouping inferred from a relationship to the storefront section being utilized by the user. For example, if a user is on a “Space Wars 1” page, the business objects for “Space Wars 2,” “Space Wars 3” and “Space Wars 4” may all be configured to be returned when a user enters this page and asks for quotes. Thus, a user may receive many business objects for many assets, and further, the business objects that are returned can be logical and relevant to the page being browsed by the user.

In one example scenario, storefront 106 may be employed to sell video on demand (VOD) assets and applications on an individual purchase basis. As yet another example, operators may use the system to sell time-based (weekly, monthly, etc.) subscriptions for VOD. As another example, an operator may sell a package of on demand movies bundled by genre, actor, etc. In other cases, an operator may want the individual movies to also be available (i.e., unbundled), but on a different pricing basis than when purchased as a group. Further, an operator could use the system to promote the package whenever a consumer thinks about renting any of these movies individually. It can be appreciated that these offers may not be mutually exclusive, in that any or all of the examples provided herein could be offered side by side in a storefront. It is with a set of standardized business objects, returned to the storefront, that an operator may offer all such possible offers. For example, in a typical scenario, many business objects may be returned to the storefront, enabling many types of offers. Accordingly, it can be further appreciated that although concepts and examples may be discussed herein with reference to a single business object enabling a single scenario, such a system for electronic transactions may include returning several business objects to the storefront, in which case a customer may encounter each of the described options in a single visit or single presentation.

Other possible use scenarios include an operator using the system to create time-sensitive pricing campaigns to drive up sales. For example, an operator may use the system to create dynamic-offer campaigns that enforce different prices depending on time of day (e.g., prime time vs. afternoon) and/or depending on a time in the month (e.g., weekend, holidays, etc.). An operator may choose to add some additional description to the offer. As another example, an operator may use the system to sell high-definition (HD) content on a limited-bandwidth or lesser-quality network using a Download and Play mechanism, wherein offers may be created that allow the consumer to play from a local disk rather than streaming the content. Further, an operator may create pricing campaigns which allow consumers to pre-order on demand and download and play content.

In another example, the quote section of the business object is used to present purchase opportunities for multiple different formats of a digital asset (e.g., viewable video for use on different tuner devices such as a mobile device, laptop, high definition television, etc.). In such a case, the elections section of the business object may be used to allow the customer to indicate the format or formats of interest.

The quote section and other sections of the business object may also be used to dynamically vary the price component of offers. In many cases, rich demand data is available showing how the demand for a given asset changes (typically decreases) over time. Such data can be used in connection with the present system to dynamically update the pricing component of the quote section in the described business objects.

Additionally or alternatively, an operator may use the system to provide free content (e.g., VOD) to consumers for content such as TV shows, educational videos, user-generated content (UGC) and the like. Further, such a system may provide the operator with the ability to track views of these free content pieces. In some cases, an operator may use auto deployment for VOD assets, and may expect offers to be automatically created on deployment based on business metadata information.

As another non-limiting example, an operator may already have a traditional offer management system deployed, and may want to replace such a system with a new system or an external offer management system with minimum operational effort. In such a case, integration may be facilitated and enhanced by the modular aspects of business object 122.

Other possible use scenarios include an operator using the system to create pricing campaigns that let the user choose from multiple offers for the same piece of content. As a non-limiting example, a campaign may include a pricing structure of $3 in standard definition, $4 in high definition or $5 without advertisements or free with advertisements. Further, an operator may be able to update prices and/or taxes for all existing offers that have a certain price or tax.

As another example, an operator may find that consumers would like the option to pay for their transactions on TV through means other than having it showing up on their TV billing statement. For example, such consumers may treat these one-time expenses as part of their entertainment budget rather than their recurring budget. As such, an operator may use the system to enable the consumers to pay using Visa, Mastercard, Paypal, etc. in addition to the credit system on the TV billing statement. Such flexibility can be accommodated via flexible offer types and through appropriate use of the elections and purchase sections of business object 122, as well as linkages to appropriate applications for such a purchase user interface.

Further, an operator may use the system to sell a bundle of content (e.g., an on demand movie, an associated on demand interview, a ringtone of the movie theme song, and a movie-related promotional item) for a bundled price. As another example, an operator may use the system to create flexible pricing campaigns such as “buy 1 get 1 free,” “buy 3 get the 4th free” and “buy 5 and get 3 free On Demand assets.” As another example, an operator may use the system to cross-promote content to drive up sales. Further, an operator may use the system to create a new campaign in conjunction with advertisers where consumers may use coupons and loyalty discounts to watch free or discounted movies. As yet another example, an operator may use the system to enable a “gift card” scenario where say, for example, a user can give his mom a gift worth 10 new high definition movies.

It can be appreciated that these use scenarios are non-limiting, and therefore are just a few of the many possible use scenarios for a system such as system 100.

Continuing with FIG. 1, and as described above, the described business objects bind a user and a set of assets to a set of providers (asset providers, billing providers, quote providers, etc.). Thus, the business objects may be considered to be the core of a purchasing workflow. When a quote provider or offer management system wants to offer an asset for sale, that person may create a business object via a mechanism such as a business object API. Thus, each element of business object 122 may pertain to a specific part of the purchase process, and the quote provider may specify as much or as little of the details as required.

In one class of examples, the quote section of the business object may act as the entry point to the business object. In other words, while in some cases the quote section will indeed identify and describe the specific asset being offered, in other cases the listed asset does not overlap, or only partially describes, the ultimate assets that are to be provided in the transaction. In particular, in some examples, quote section 124 may not define the asset that is delivered at the completion of a purchase, since fulfillment section 130 can provide that detail. The asset specified in quote section 124 may simply be used for routing. That is to say, the entry point to business object 122 may be a single “AssetID,” but any number of assets may be described and purchased by quote section 124. This freedom allows for handling of multiple assets, or packages that include external assets, or “up-sells” that are offered when a user browses an asset page but is sold something else. No link may be required between the asset in the quote section 124, and the assets in the fulfillment section 130, other than the provider's desire to offer the assets of the fulfillment section 130 when a client is browsing the asset of quote section 124.

When a business object, such as business object 122, is defined using the business object API, many “principals” may be associated with the business object. However, when a business object is issued for a given client, one principal may be specified in the full business object (i.e., the principal that applies to the

The monetary details of the transaction between the buyer and the seller may then be held in purchase section 128. Such a purchase section may further include workflow items that occur during a purchase. As an example, if a credit card is rejected, the purchase section may prompt the option of using PayPal or another alternate mechanism. Possible workflows supported by purchase section 128 include a rejection workflow and a response workflow. Further, a purchase may not be complete until a “purchase authority” indicates approval, for example, by setting a flag to true. Fulfillment section 130 of business object 122 then describes the items purchased by the client. Both external and internal items may be described within fulfillment section 130.

Accordingly, such a system for conducting electronic transactions may allow for increased efficiency, in that each party is familiar with the structure of the business object. Further, the configuration of the business object may allow for tasks performed in connection with the transaction to be performed by an entity most suited to perform the task. In other words, system 100 can facilitate easy and effective use of external systems.

Further, such a system may allow for an operator and/or other parties to easily search for and identify offers of interest, in order to view offers, edit offers, tie to other offers, etc. Generation of such offers may not only be easier via system 100, but even relatively complex offers may be generated. Further, such a system may provide advanced content promotion opportunities in response to user preferences, allowing a seller to upsell, cross-promote, etc. and otherwise target consumers.

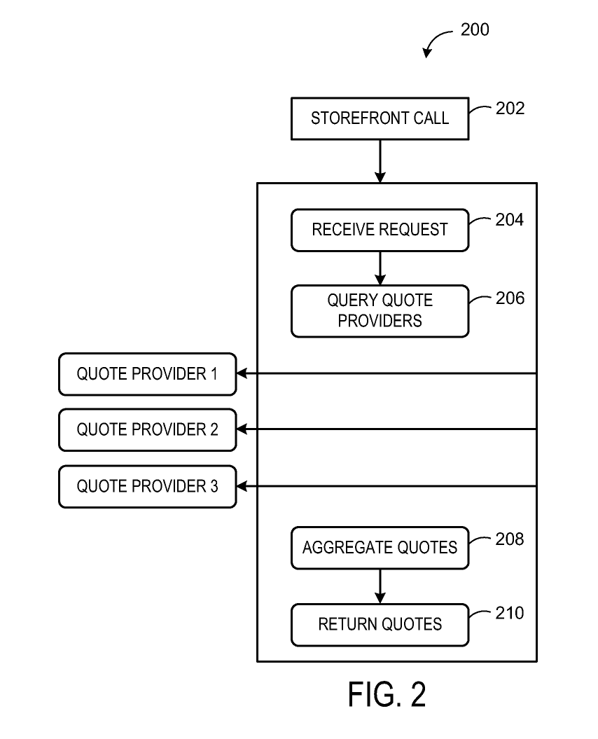

The configuration of system 100 may further allow for advanced reporting and dynamic modification, and thus system 100 may be easily extensible. Further, system 100 as configured may be robust and scalable, allowing for flexibility in business models. Such a system can further facilitate asset sale and distribution for different types of content in different formats to different devices. Various examples of possible workflows for a system for conducting electronic transactions are described in more detail hereafter with reference to FIGS. 2-4.

FIG. 2 shows a flow diagram illustrating an example workflow 200 for a system for conducting electronic transactions. The storefront is called, as indicated at 202, and upon receiving a request at 204, one or more quote providers may be queried as indicated at 206. For example, Quote Providers 1, 2 and 3 may be queried. Upon aggregating the quotes at 208, the quotes may then be returned as indicated at 210.

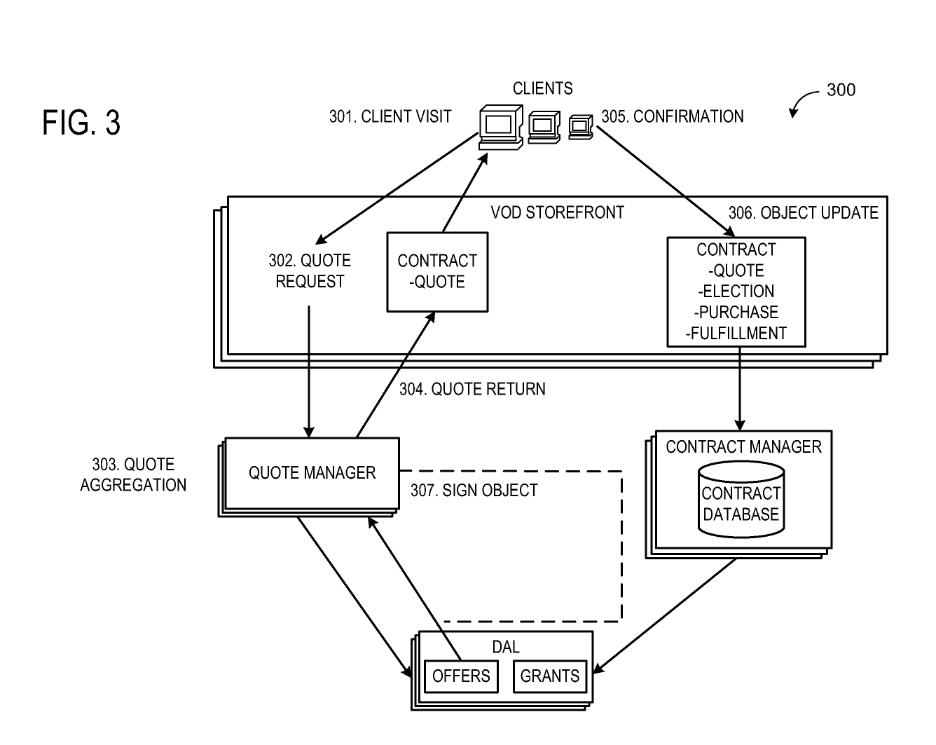

FIG. 3 shows a flow diagram illustrating an example workflow 300. At 301, a client may visit a VOD store detail page, which may be presented, for example, via a VOD storefront. At 302, the storefront requests one or more quotes for an asset of interest. It should be appreciated that the asset of interest may be identified in a variety of different ways. For example, business objects corresponding to assets of interest may be identified based on prior usage behavior of the customer, such as browsing history or previously-viewed pages in the storefront. This may be achieved by searching a plurality of existing business objects in order to match an object based on usage behaviors of the purchaser. As previously indicated, the modular and standard nature of the quote section and other sections may facilitate such searching in order to quickly and accurately identify relevant assets and the corresponding business objects. In other examples, quotes may be provided to the potential purchaser in response to explicit requests or queries submitted to the storefront.

In any case, once a particular asset of interest is identified, a quote manager may then aggregate and normalize quotes for the asset, as shown at 303. At 304, the quote manager may then return the quote to the storefront. As such, a quote section may be added to the business object (i.e., contract), and viewable representations of the quote information may be presented to the potential purchaser. The quote manager may further cache the quote if specified by the cache directive. At 305, the purchaser confirms their purchase. The storefront then fills out or further updates the business object, for example, by completing the election, purchase and fulfillment sections, as shown at 306. At 307, the business object may be signed or otherwise validated/authenticated. The business object manager (i.e., contract manager) may confirm the quote is valid in that no grants exist. Accordingly, the business object manager may then implement the fulfillment mechanism specified in the business object. As an example, grant and billing records may be created.

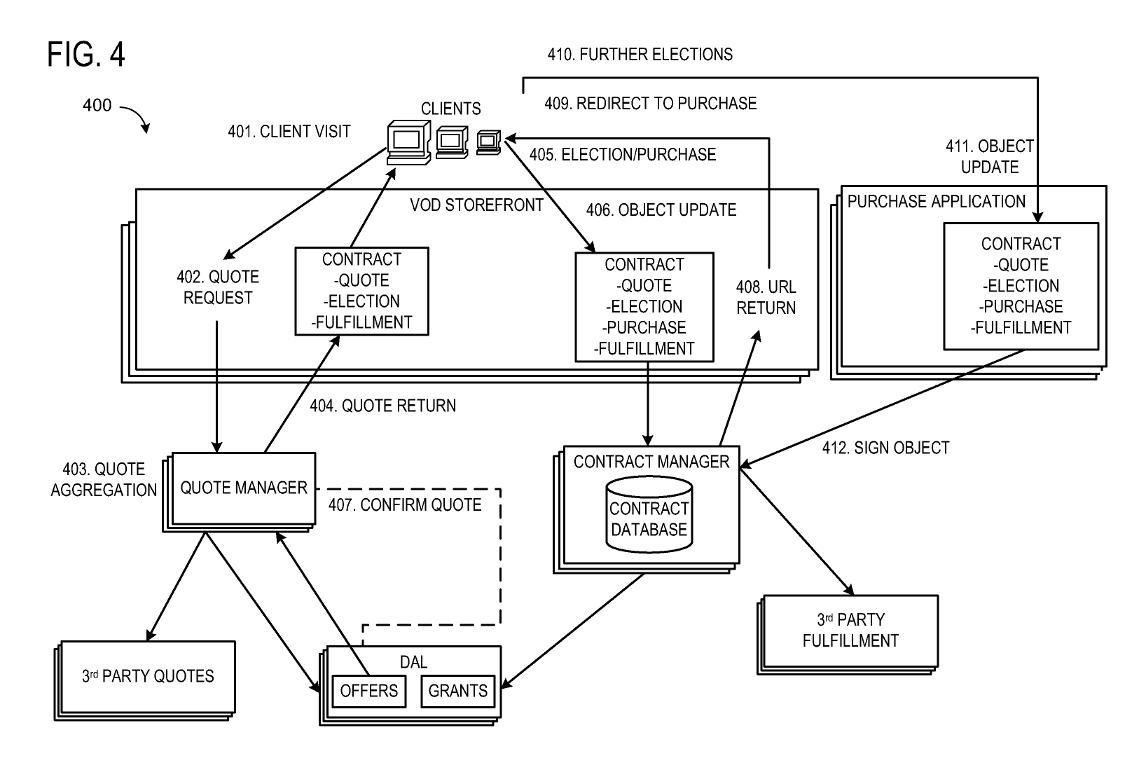

FIG. 4 shows a flow diagram illustrating an external purchase workflow 400. At 401, a client may visit a VOD store detail page, which may be presented, for example, via a VOD storefront. At 402, the storefront requests one or more quotes for the asset from one or more external quote providers. As indicated above, assets of interest may be identified via interest matching, explicit customer request, etc. A quote manager may then aggregate and normalize quotes for the asset, as shown at 403. At 404, the quote manager may then return the quote to the storefront. As such, a quote section, an election section and a fulfillment section may be added to the business object (i.e., contract). The quote manager may further cache the quote if specified by the cache directive. At 405, the client may make an election and may ask to purchase an item. The storefront then fills out the entire business object, for example, by completing the purchase section, as shown at 406. At 407, the business object manager (i.e., contract manager) may confirm the quote is valid in that no grants exist. Accordingly, the business object manager may further determine if additional pre-purchase data is required. At 408, a purchase uniform resource locator (URL) may then be returned to the client. Accordingly, at 409 the client may then be redirected to the purchase application. At 410, the client may provide further elections, such as a delivery mechanism, upsell, payment, and the like. At 411, the purchase application may then fill out the rest of the business object, and submit the business object. As such, at 412 the business object may be signed to provide validation/authentication. The business object manager (i.e., contract manager) may then implement the fulfillment mechanism specified in the business object. As an example, a grant may be created and third parties may be notified.

From the above, it should be appreciated that the workflow of FIG. 4 is similar in many respects to that of FIG. 3. Both workflows describe a system in which multiple business objects are generated representing potential transactions for a variety of different assets. In each case, an asset of interest is identified (e.g., through interest matching, explicit request from potential purchaser, etc.) and the corresponding business object or objects are selected. A viewable representation of the quote is provided to the potential purchaser, and input is received in order to populate/update the elections section of the business object. One distinction of FIG. 4 is that it illustrates the use of the business object to enable efficient use of third parties to perform transaction-related fulfillment. Specifically, the figure shows how the business object is made available to one or more third parties so that those third parties can consummate the transaction in accordance with the payment section and/or fulfillment section of the business object.

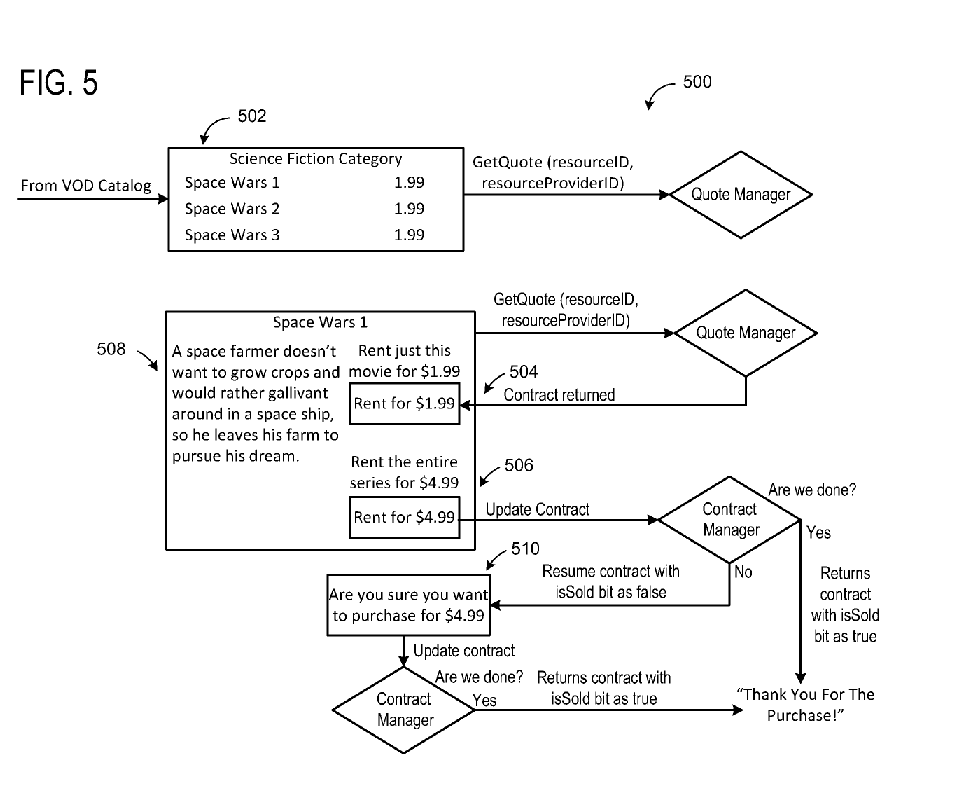

FIG. 5 shows an example logic flow for a purchasing process. In a first example, shown generally at 502, a list of available movies may be obtained from the VOD catalog. For example, a series of related movies may be displayed. Additionally, the storefront may request a quote from the quote manager for each of the available movies in the list and the quotes may be displayed for each of the available movies, for example, in a column as shown at 502.

Furthermore, the information at 504 may be presented to a user responsive to selection of a particular movie from the list shown at 502. For example, if a user selects the movie “Space Wars 1” from the list at 502, the storefront may send a request to the quote manager for a quote and/or additional information associated with the selected movie. The quote manager may then return a business object (i.e., contract) including a quote for the individual movie. As shown in this example, the quote manager may also return associated quotes, such as a quote for a series of movies related to the selected movie. In some examples, the quote manager may update the business object to include a quote for renting an entire series of related movies, for a bundled price such as shown at 506 such that it the entire series is presented as an option concurrent with the option to purchase the single movie. In another example, the quote manager may update the business object to include a quote for renting the entire series of related movies in response to a purchase of the single movie. Notably, the quote manager can also return metadata, such as a summary of the selected movie indicated at 508, in order to assist the user in a user's purchase decision.

In this example, responsive to a user selection to purchase the series of movies, a request to update the contract may be sent to a contract manager. The contract manager may then determine if the purchase is completed. If so, then the contract manager may return a sold flag with a “true” state. However, if the contract manager determines the purchase is not complete, it may return the sold flag with a “false” state, and negotiation of the contract may still be in progress. As such, a user may receive a message such as that shown at 510, asking the user to indicate if they would like to purchase the entire series of related movies. Thereafter, the contract manager may receive an input (e.g., based on a user selection) to update the contract. If the user has confirmed they would like to purchase the entire series of related movies, the sold flag is returned with a “true” state. However, if the user declines purchase of the entire series of related movies, the state of the sold flag is maintained as “false”, and the routine may end, or the routine may return to an earlier step.

According to another example, only one movie is obtained from the VOD catalog. In such an example, the storefront may request a quote for the movie and the information shown generally at 504 can be displayed to a user.

This logic flow is exemplary and not meant to be limiting. For example, the information at 504 may be displayed to a user concurrent with the information displayed at 502, whereas in other example, the information shown at 504 may be displayed responsive to selection of the movie “Space Wars 1” from the list at 502.

As described above, a business object may be configured in any suitable manner. In many example settings, the business object is initially instantiated with many sections and section components set to null or some other placeholder value. As the object is used by various entities, values will be filled in with transaction-specific details (e.g., assets being offered, pricing information, purchaser elections, payment information, etc.)

Furthermore, it will be understood that the various sections of business object 122 may be configured in a variety of ways. Non-limiting examples of subsections and fields that may be included in the quote section of a business item include:
QuoteID, QuoteProviderID—fields that may be used to identify the quote and the authority that owns the Quote
Principal—identifies the principal associated with a quote
AssetID, AssetProviderID—fields that may be used to identify the asset that a client requests a quote for, and the authority that owns the Asset
QuoteStartDate, QuoteEndDate—fields that may be used to describe the duration in which a quote is valid
EventStartDate, EventEndDate—fields that may be used to identify the start and end of an event associated with the quote (PPV, discount window, etc)
QuoteType—describes the package type represented by the contract (i.e. single asset, group of assets, subscription, etc.)
QuoteText—description of the quote
RelatedQuoteURl—a URI to any resource that is required to display quote detail
QuotePrice, QuoteTax, QuoteCurrency—describe deal pricing
PresentationBody—the body that describes the Quote
PresentationType—type of body (i.e. Text, HTML, XAML, etc.)

The elections section may similarly be configured to include a variety of different subsections and fields. Non-limiting examples include:
ElectionDate—date on which the election was made by the client
IsPurchaseRequested—flag set by client, indicating acceptance of quote terms
IsElectionRequired—flag set by quote provider, indicating expected use of ElectionBody
ElectionBody—fulfillment providers specify the data they require storefronts to capture and store here in order to complete a purchase (e.g., Large T-Shirt).
ElectionType—describes how the ElectionBody is interpreted (Text, URI, Culture which identifies language and country of offer/quote, etc.).

The purchase section may similarly be configured in any suitable manner. Non-limiting examples of subsections and fields include:
PurchaseID, PurchaseProviderID—distinctly identifies the instance of the contract and client, and the authority that owns the purchase
ClientID—identifies the client, for example via an identification of the client's set top box
PurchaseType—describes whether an external purchase site visit is required
RelatedPurchaseURl—identifies the URI that the client/storefront is expected to complete the purchase
PurchasePrice, PurchaseTax, PurchaseCurrency—identifies pricing information for the deal
PurchaseRequestDate—identifies the date and time the purchase was requested
PurchaseCompleteDate—identifies the date the purchase authority completed the purchase
IsPurchaseComplete—flag set by purchasing authority, indicating purchase is complete
IsPurchaseRejected—flag set by purchasing authority, indicating purchase is rejected
PurchaseRejectionBody—body of rejection text
PurchaseRejectionType—describes the purchase rejection body (i.e. Text, HTML, XAML)
IsResponseRequired—flag indicating if purchase authority requires response to be sent to client
PurchaseResonseBody—body of response text
PurchaseResponseType—describes the purchase response body (i.e. Text, HTML, XAML)
IsPurchaseRecurring—Sets the purchase to recur on a monthly basis

The fulfillment section may be configured in any suitable manner.
Non-limiting examples of subsections and fields include:
AssetID, AssetProviderID—identifies asset and owner/authority
AssetProviderURl—in the case where the purchase is completed by someone other than the authority for the asset, this may be used to identify a URI to fulfill the purchase of the asset, if an external provider is employed.
URICompleteDate—identifies the date that the external URI was called
IsURIRequired—determines if the Contract must be passed to an external fulfillment authority to complete the fulfillment
IsElectionRequiredByURI—determines if the election must be included in the contract when passed to the external fulfillment authority (this would allow sensitive items described by the client to be held back, if set to false)
IsURIComplete—describes if the external URI was called
BillingCompleteDate—defines the date that the billing record was created
IsBillingRequired—determines if a billing record should be created
IsBillingComplete—determines if the billing record was created
GrantStartDate—grant data for this asset
GrantEndDate—grant data for this asset
EventStartDate—start date/time of event associated with the fulfillment (PPV, etc)
EventEndDate—end date/time of event associated with the fulfillment (PPV, etc)
GrantDuration—grant data for this asset
GrantType—grant data for this asset

In some embodiments, the above described methods and processes may be tied to a computing system. It will be appreciated that such a computing device may be any suitable computing device configured to execute the programs described herein. For example, the computing devices may be a mainframe computer, personal computer, laptop computer, portable data assistant (PDA), computer-enabled wireless telephone, networked computing device, television, mobile device, or other suitable computing device, and may be connected to each other via computer networks, such as the Internet, and/or may be served by a cloud computing device. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A business object for mediating an electronic transaction, comprising:
a plurality of modular object sections configured to be recognized by different transacting parties as standard agreed-upon descriptors of an electronic transaction, where read/write permissions vary from section to section and depending on a given party's relationship to the electronic transaction, the plurality of modular object sections including:
a quote section which indicates willingness of a seller to transfer rights in an asset to a purchaser in exchange for consideration provided by the purchaser, the quote section being modifiable so as to cause transformation of a viewable representation presented to the purchaser;
an elections section containing parameters of the electronic transaction that are modifiable in response to input received from the purchaser; and
a fulfillment section containing fulfillment information relating to actions to be taken in order to achieve the transfer of the rights in the asset to the purchaser.

2. The business object of claim 1, where the quote section is configured to enable a seller to make rights available for multiple different formats of a digital asset, the elections section being configured to store a purchaser's selection of one or more of the multiple different formats.

3. The business object of claim 2, where the multiple different formats are made available to accommodate consumption of the digital asset on different types of tuner devices.

4. The business object of claim 1, where the quote section is configured to be populated with information concerning any of a plurality of different types of assets from any of a plurality of different unaffiliated selling parties.

5. The business object of claim 1, where the business object is generated and maintained by an electronic storefront that mediates transactions between purchasers and third-party sellers.

6. The business object of claim 5, where the storefront is further configured to search a plurality of business objects and to match one or more business objects to a purchaser based on usage behaviors of the purchaser.

7. The business object of claim 1, where the plurality of modular object sections further includes a purchase section containing purchase information for the electronic transaction, such purchase information including identification of a payment mechanism to be employed for the electronic transaction.

8. The business object of claim 1, where the asset associated with the business object is servable from a network and is consumable by one or more of a computing device, a television, and a mobile device.

9. A method of operating an electronic storefront to facilitate transactions between sellers and purchasers, comprising:
generating a plurality of business objects representing potential transactions for a plurality of different assets, each of the business objects containing a plurality of modular object sections configured to be recognized by different transacting parties as standard agreed-upon descriptors of an electronic transaction, the plurality of modular object sections for each of the business objects including a quote section, an elections section, a purchase section and a fulfillment section;
selecting one of the plurality of business objects to potentially effect an electronic transaction between a seller and a purchaser;
presenting to the purchaser a viewable representation of the quote section of said one of the plurality of business objects;
receiving input from the purchaser to populate parameters within the elections section of said one of the plurality of business objects, said input causing transformation of information contained within the purchase section and the fulfillment section of said one of the plurality of business objects; and
making said selected one of the plurality of business objects accessible to one or more third parties to enable said one or more third parties to consummate the transaction in accordance with information contained in the payment section and the fulfillment section of said one of the plurality of business objects.

10. The method of claim 9, where selecting one of the plurality of business objects includes determining potential interest of the seller in acquiring rights in an asset that are grantable by the purchaser.

11. The method of claim 9, further comprising conducting a search within the electronic storefront to identify all offers accessible via the electronic storefront and that pertain to a selected asset, where said conducting includes querying of the quotes sections of the plurality of business objects.

12. The method of claim 9, where one or more different business objects each having a different transaction condition are associated with a same asset, and where presenting the viewable representation of the quote section includes presenting a viewable representation of each quote section associated with each business object.

13. The method of claim 9, further comprising dynamically varying a price included within the quote section based on one or more parameters of the electronic transaction.

14. The method of claim 9, further comprising tracking usage behaviors of a purchaser and searching for one or more business objects based on said usage behaviors.

15. The method of claim 9, where each of the plurality of different assets is servable from a network and is consumable by one or more of a computing device, a television, and a mobile device.

16. An electronic storefront configured to facilitate transactions between sellers and purchasers, the electronic storefront comprising:
a plurality of business objects representing potential transactions for a plurality of different assets, each of the business objects containing a plurality of modular object sections configured to be recognized by different transacting parties as standard agreed-upon descriptors of an electronic transaction, where for each of the plurality of business objects, the plurality of modular object sections includes a quote section, an elections section, a purchase section and a fulfillment section;
a purchaser interface, where each of the plurality of business objects is configured to provide a viewable representation of its quote section, said viewable representation being presentable to potential purchasers via the purchaser interface, said viewable representation indicating willingness of a seller to transfer rights to one of the plurality of different assets to a purchaser in exchange for specified consideration from the purchaser, and where the purchaser interface is further operable to receive purchaser input in response to the viewable representation in order to cause modification of transaction parameters stored within the elections section of the business object; and
a third party interface via which the electronic storefront interacts with a third party to enable such third party to perform a transaction fulfillment action in accordance with information contained in the fulfillment section of the business object.

17. The electronic storefront of claim 16, where each of the plurality of different assets is servable from a network and is consumable by one or more of a computing device, a television, and a mobile device.

18. The electronic storefront of claim 16, where the electronic storefront is further configured to track usage behavior of a purchaser and to select one or more business objects for the purchaser based on said usage behavior.

19. The electronic storefront of claim 16, where the purchaser interface is further operable to cause modification of transaction parameters by dynamically varying a price included within the quote section of a business object.

20. The electronic storefront of claim 16, where the transaction fulfillment action causes a transfer of rights in an asset to a purchaser.
